(19) United States
(12) Patent Application Publication
(10) Pub. No.: US 2011/0055039 A1
(43) Pub. Date: Mar. 3, 2011

(54) Bidder identity encryption for enabling an audit trail

(76) Inventor: Adolfo Paz, Long Beach, CA (US)

(21) Appl. No.: 12/806,272

(22) Filed: Aug. 9, 2010

Related U.S. Application Data
(60) Provisional application No. 61/275,357, filed on Aug. 28, 2009.

(51) Int. Cl. G06Q 30/00

(52) U.S. Cl. 705/26.3

(57) ABSTRACT

A computer network implemented public auction preserves audit trail data in a remotely secured storage site which may be accessed by subscribing auction participants in the event auction fraud or collusion is suspected. To insure the authenticity of the stored data and to verify the identities participating in the auction a unique encrypted identification code is assigned to each bidder after the bidder's identity is verified against public data banks and once so verified is stored in association with the image and/or document record sequences for a period determined by the subscription agreement and/or the relevant statute of limitations period.

### BACKGROUND OF THE INVENTION

### Reference to Related Application

This application obtains the benefit of the earlier filing date of U.S. Provisional Application Ser. No. SN 61/275,357 filed on Aug. 28, 2009.

### FIELD OF THE INVENTION

The present invention relates to computer enabled competitive bidding systems, and more particularly to a bidding method in which each of the competing bidders is assigned an encrypted identity code that is matched and stored with recorded image and other data to preserve an audit trail useful in reviewing a bidding process suspected of collusive acts.

### DESCRIPTION OF THE PRIOR ART:

The current state of our economy has injected into the marketplace, in inordinate numbers, various kinds of foreclosed security, or securing property, which in the ordinary course of business is publicly offered and thereafter sold in a public auction that ideally would preserve and assure the foreclosed debtor a process endowed with some basic fairness. Without such a notion even the most objective debtor, in time, begins suspecting that the auction process was unfair and all sorts of lawsuits then follow. The current debt default numbers, however, have grown so large that any single foreclosing creditor is simply unable to fully address these concerns and is therefore compelled to defer the task instead to professional auctioneers and promoters who, in turn, may themselves expose the creditor to claims that the auction was somehow unfair, or even fraudulent.

Of course, there are other instances where the efficacy and correctness of the bidding process becomes an issue. For example those charged with the disbursement of public or charitable funds must always maintain a vigilant posture against possible claims of waste, or even charges of collusion, that surface with some frequency in a political process should they try to handle the auction process themselves and deference to a professional is therefore universal. While such deference may be dictated by the current volumes, and therefore makes good personal and business sense, the foreclosing creditor nonetheless must include into the process convincing audit trails both to withstand the frequent debtor or competing bidder claims alleging that the auction was somehow unfair and/or mishandled, or the claims of the fund owners that the bidding was potentially collusive for lack of security, and so on, complaints particularly fostered by this economic climate where the same foreclosure volumes that dictate the engagement of professional auctioneers are also the cause of low auction prices.

Recently the developments in various auctions and bidding processes have been driven by the growth of Internet commerce, exemplified by the various computer implemented and web connected auction systems like the well known processes provided by eBay or Priceline. In these processes various consumers compete for the goods or services provided by various participating businesses and the main security aspects of the process are those important to its provider and not those of the bidder or seller.

Thus the prior art includes various Internet enabled techniques in which the bidder's particulars are collected to effect the eventual payment, as in U.S. Pat. No. 7,523,063 to Harrington et al.; the bidders are grouped and sorted in accordance with their product or capability, as in U.S. Pat. No. 7,401,035 to Young; and/or the bids are grouped in accordance with some current value measure of the bid amount that is distributed in time, as in U.S. Pat. No. 7,010,511 to Kinney, Jr. et al. Alternatively the prior art deals with the data communication and handling process itself, as in U.S. Pat. No. 7,299,207 to Gologorsky et al.; and/or the network management as in U.S. Pat. No. 7,523,063 to Harrington et al.

For all these reasons a bidding process that preserves an audit trail focused on its integrity aspects assures the interests of all the parties to the auction is extensively desired and it is one such process that is described herein.

### SUMMARY OF THE INVENTION

Accordingly, it is the general purpose and object of the present invention to provide a computer network enabled bidding process in which each bidder is assigned and encrypted bidder identification form unavailable to any other participant, including the auctioneer, with the bidding sequence of these encrypted identifications then remotely stored to provide an audit trail.

These and the many other objects of the invention shall become apparent upon the inspection and review of the description that follows in conjunction with the illustrations accompanying.

Briefly, these and the other objects are accomplished within the present invention by providing within a computer network a printing, marking or electronically imbedding a signal sequence facility which inscribes onto each bidder's stationary, in those instances where the bidding is effected by exchange of documents, identification sign, if the bidding is in the course of a live auction, or a signal sequence, if by Internet, an encrypted identification code which is then read and recorded at the time each bid is received. Concurrent therewith this same encrypted identification code is stored in a remotely located and secure facility, such as a remote server, in association with the financial and identity data to whom the encrypted identification has been assigned.

The foregoing encrypted markings, or signal sequences, may take the form of barcode strings that are then readable by any commercially available barcode reader, a two-dimensional matrix encrypted as exemplified in the teachings of U.S. Pat. No. 4,972,475 to Sant'Anselmo and organized as in the teachings of U.S. Pat. No. 5,612,524 to Sant'Anselmo et al., and thereafter read by a portable reader as exemplified in U.S. Pat. No. 5,331,176 again to Sant'Anselmo et al., the teachings of each being incorporated by reference as if fully set out herein, or in any other well known encryption format currently utilized in sensitive signal transmissions on the Internet. Preferably these assignments of encrypted identity codes precede the time aperture of the auction itself with the outgoing code from the assigning server then disconnected from the bidding process to insure both temporal and spatial separation of the outgoing data from remote server from the site and time in which the auction is conducted.

While these security aspects of the foregoing arrangement, in themselves, may be sufficient to discourage those bent on collusive rigging, the persistent fond adventurers that may still persist will be further discouraged in their forgeries in the course of a live auction by storing in the reconciliation and audit information the bidder's image data along with each bid. Alternatively, for those bidding processes that are carried out by encrypted electrical signals transmitted over the web or those that entail a hard copy transmission of paper documents a bidder selected password may be required along with the encrypted identity sign.

Those skilled in the art will appreciate that the foregoing process vests in those controlling the remote server all sorts of other data that may be included in the encrypted space. For example, the same bar code or two dimensional array that is encrypted to distinguish the bidder may also include the bidder's financial limits and other data distributed therein that will be available to the auctioneer, but only when read in the course of the auction itself. Thus if the bidding persists after the limit is exceeded a clear indication of potentially collusive bidding is displayed. In this manner virtually all of the known bid rigging techniques are addressed resulting in a stored record that is likely to impede those bent on cheating.

### BRIEF DESCRIPTION OF THE DRAWINGS

FIG. 1 is a diagrammatic illustration of a computer network connected server site conformed to transmit to and receive from a selected one of a plurality of network connected local computer stations data and to process and store said data by reference to encrypted identification codes read by said network connected computer stations;

FIG. 2 is a flow chart illustration of a sequence of computer operations distributed between the selected one and the other computers and the server site for effecting the logical sequences in accordance with the present invention; and

FIG. 3 is a diagrammatic illustration of a split screen image record useful with the present invention in accordance with the operation thereof during the conduct by an auctioneer of a live auction, recording any possible interchanges between the auction participants.

### DESCRIPTION OF THE PREFERRED EMBODIMENT

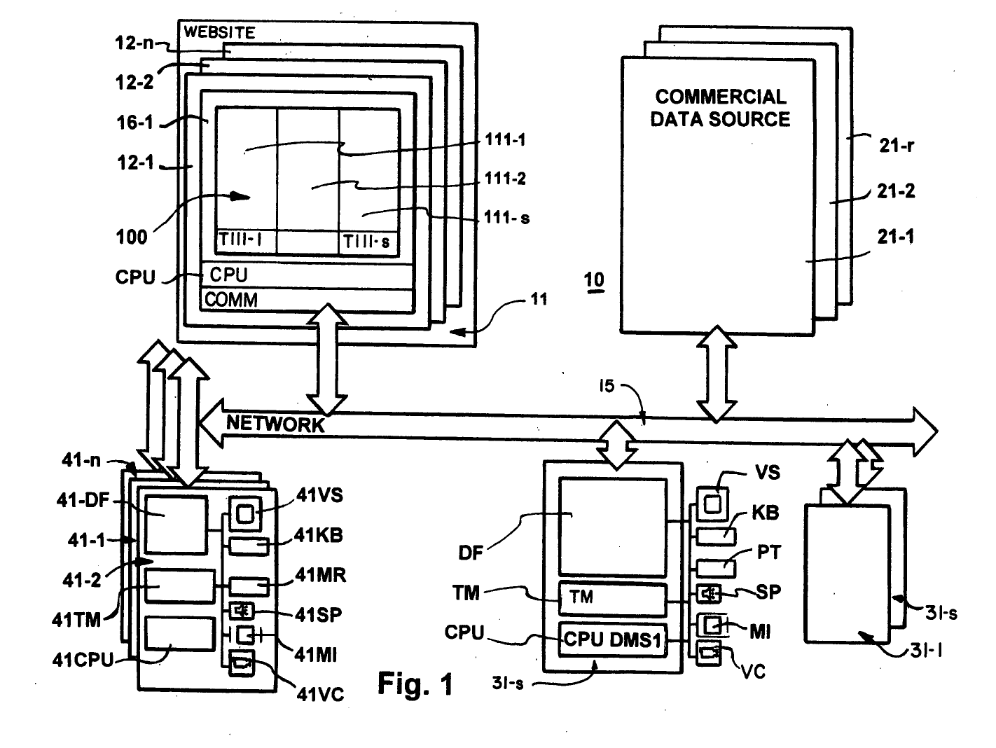

As shown in FIGS. 1 through 3 the inventive audit data collection process generally shown under the designation 100 is carried out on a computer network enabled system generally designated by the numeral 10 in which a website 11 is implemented to include one or more servers 12-1 through 12-n each dedicated to monitor and store the data associated with a particular auction tied either directly or indirectly to a computer communication network 15 like that generally referred to as the Internet to effect this task. While each of the servers is sometimes supported by its own central processing unit [CPU] 14-1 through 14-n the interconnections therebetween may be variously distributed, either in subordination to a selected one CPU, sometimes referred to as multitasking, or in an equal ranking format referred to as parallel processing. It is these servers 12-1 through 12-n that that each communicate by network 15 to the particular user's site to either monitor a separate one of several bidding events in accordance with the present invention, or to assign and provide an encrypted identification tag to each bidder and thereafter record the bidding information associated therewith.

To effect these operations each of the servers 12-1 through 12-n, moreover, includes its own corresponding memory 16-1 through 16-n in which the separated operations of the interactive process 100 are distributed, first as the assigning source of encrypted identification codes in association with the identity data provided by each bidder, and thereafter as the storage of bidding data that may include either the matching of password data of the respective bidders or the visual image of the bidder him or herself, as in the course of a live auction.

While there are various techniques useful in generating an encrypted label or tag, one preferred example is the technique described in the above referred and incorporated herein Saint'Anselmo patents, barcode sequences or Radio Frequency Identification Devices [RFIDs] which may be utilized to harvest further bidding data along with the bidding process at the bidding site by various readers that may be coupled with a video camera, barcode reader and/or other identification means like the variously implemented RFID sensors, or those illustrated by example herein as a auction site matrix reader 41MR according to the Saint'Anselmo teachings, or even a biometric process that scans and recognizes physical features.

To further enhance and/or verify the bidders' identification further data may be obtained by communicating through network 15 to various other commercial data sources shown as websites 21-1 through 21-r which may include the several credit verification agencies like Equifax TM, requiring the bidder's consent. Alternatively, address verifications can be obtained from publicly accessible sources such as MapQuest™ by MapQuest, Inc., 555 17^{th} Street, Suite 1600, Denver, Colo. 80202 or Zillows ™ by Zillow.com, 999 Third Ave., Suite 4600, Seattle, Wash. 98104, which store the particulars of an address, and/or an estimate of the value of the residence at that address, in combination with an overhead view thereof by way of various contractual arrangements with a particular overhead view provider.

In each instance these and similar commercial websites provide linking arrangements which then either find a corresponding match in their data base or simply return a ‘can't find’ message if no match is found. This then may be utilized to either disqualify the bidder, or to modify the observation of the bidder to discern any patterns of bid rigging and the like.

Along with these commercial auction network users are also the vast plurality of the prospective individual bidders, i.e., the potential auction base, that through their personal data processing interface facilities 31-1 through 31-s are tied to network 15. While one may always desire that each of these processing facilities be capable of some advanced data communication rates, the actual data rates of these interfacing facilities vary widely. Nonetheless each bidder's processing facility, illustrated here by reference to the exemplary local system 31-2, includes the components of a data processing device including a video screen VS, a keyboard KB, a central processing unit CPU, a temporary memory TM and a permanent, high volume memory or disc file DF.

Along with these there may also be often provided audio speakers SP and a microphone MI by which spoken messages can be exchanged and/or a video camera VC for collecting and transmitting video images. Of course, also included with each bidder's local facility will be a printer PT useful in printing the encrypted barcode or matrix tag onto all of the bidder's bid related stationary BRS.

Each auctioneer, in turn, may be similarly implemented and connected to the network 15 by way of a local system 41-1 through 41-n assigned to communicate with a corresponding one of the several servers 12-1 through 12-n that monitors and stores the particular bidding process. As illustrated by reference to auction terminal 41-2 each bidding station includes its own a data processing assembly which, in a manner similar to that previously described, includes once again devices such as a video screen 41VS, a keyboard 41KB, a central processing unit 41CPU, a temporary memory 41TM and a permanent, high volume memory or disc file 41DF.

In accordance with one form of the invention herein station 41-2 may also include the above referenced two dimensional tag reader exemplified here as the matrix reader 41MR, organized and operating in accordance with the teachings as exemplified in the above-referenced U.S. Pat. No. 5,331,176 to Sant'Anselmo et al. The local bidding station may include further an audio speakers 41SP, a microphone 41MI by which spoken messages can be exchanged and transmitted for storage and/or a video camera 41VC for collecting and transmitting video images that may be evoked in the interactive exchanges of a bidding process. The data thus generated and transmitted in the course of the auction is then collected and permanently stored in the corresponding servers 12-1 through 12-n for future reference in the event that any part of the process is challenged.

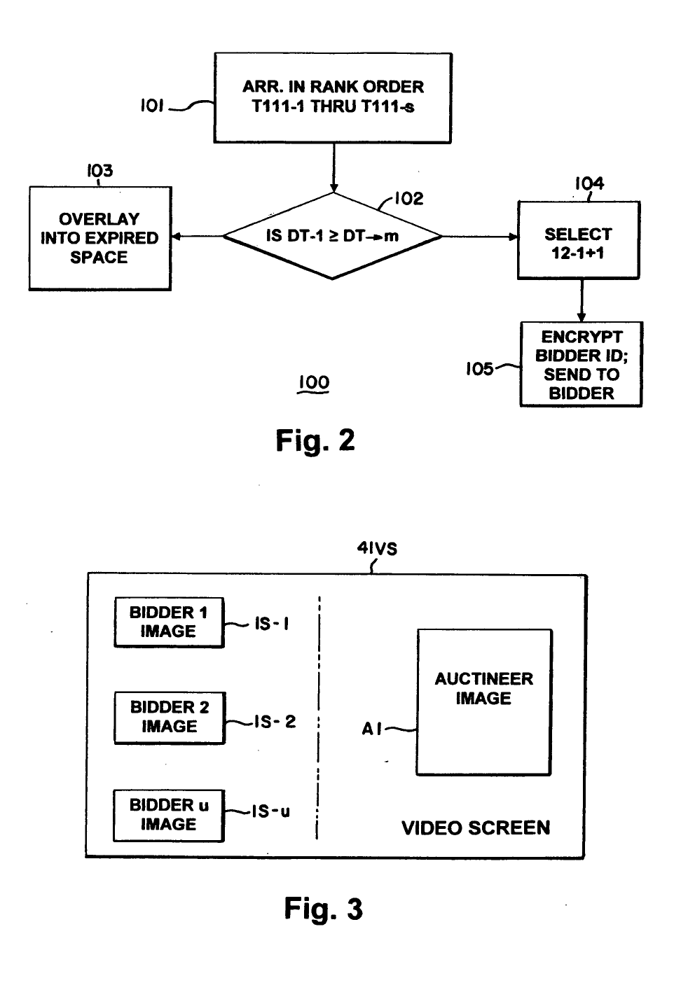

By particular reference to FIGS. 2 and 3 those skilled in the art will appreciate that each of the servers 12-1 through 12-n may include storage capacities that are substantially greater than the data collected in the course of the bidding process, i.e., the data content collected in the course of execution of each logical sequence 100. Accordingly, more than one bidding record, exemplified by data sequences 111-1, 111-2 through 111-s, may be stored in each server 12-1 through 12-n, each stored in association with a required storage term T111-1 through T111-s as may be dictated by any statute of limitations periods or the period requested by, for example, the prevailing bidder. Of course, since all data storage entails some cost the selection of the corresponding storage periods T111-1 through T111-s may be either determined by the assessment of potential bid rigging (and therefore exposure to the costs of future litigation) or may be simply a cost choice by the auctioneer or the prevailing bidder.

These considerations of cost of risk exposure and/or revenue garnering then dictate the average time commitment of each server 12-1 through 12-n and therefore the logical overlay process of any new bidding data on top of the data space occupied by prior data that has now expired, a response evoked by the timing increment DT-1 through DT-m that may be inherent any one bidding process. Thus the process 100 in step 101 arranges in a rank ordered sequence the storage periods T111-1 through T111-s. In step 102 the interval between the furthest expired data set and the closest unexpired data set is determined and compared against the particular bid timing increment DT-1 through DT-m and if greater then the bid data space of the corresponding bid process is designated in step 103 to be overlaid into the expired space.

If, however, the comparison in step 102 is not satisfied, indicating that the particular server 12-1 through 12-n does not have the available space, then in step 104 the next server is selected to repeat the same sequence. In this manner the proposed bidding record assignment is logically advanced until the necessary record space is found and once that occurs then in step 105 a set of bidder identity marks are encrypted and distributed by way of the network 15 to the appropriate bidder stations 31-1 through 31-n.

Those skilled in the art will further appreciate that the data content of the bidding process may include a sequence of corresponding split image sets on the video screen 41VS, as illustrated in FIG. 3, capturing in coherent relationships the images IS1-ISu of each bidder along with the auctioneer image AI, thus rendering the inventive process particularly effective in capturing and storing any hidden signals in the course of a live bidding process. In this manner most or all mechanisms for collusion are preserved, with the subsequent risk of exposure then greatly discouraging those adventurers that may be bent on carrying out their fond dreams.

Obviously many modifications and variations of the instant invention can be effected without departing from the spirit of the teachings herein. It is therefore intended that the scope of the invention be determined solely by the claims appended hereto.

I claim

1. A computer network implemented method of preserving secure audit trail data associated with a public auction, comprising the steps of:
comparing the identity data provided by prospective bidders against a data set contained in a commercial data bank;
selecting from the prospective bidders a list of selected bidders on the bases of said comparison of the data provided and said data set;
assigning to each selected bidder participating in said auction an encrypted unique identification code;
remotely storing said encrypted unique identification code in association with a record of each bidding act by the selected bidders associated therewith; and
retrieving said remotely stored data and record.

2. A method according to claim 1, wherein:
the step of remotely storing further includes the step of limiting the duration of said remote storing.

3. A method according to claim 2, wherein:
the step of limiting the duration of storage is based on the limitation period for commencing a civil action.

4. A method according to claim 3, wherein:
the step of limiting the duration of storage further includes the step of receiving compensation corresponding to said duration.

5. A method according to claim 4, wherein:
the step of limiting the duration of storage further includes replacing said encrypted unique identification code in association with a record of each bidding act by the selected bidders associated therewith collected in the course of said public auction with another encrypted unique identification code in association with another record of each bidding act by the selected bidders associated therewith collected in the course of another public auction.

6. A computer network implemented method for conducting a public auction, comprising the steps of:
selecting from the prospective bidders a list of selected bidders upon the verification of the identity thereof;
assigning to each selected bidder an encrypted unique identification code;
remotely storing said encrypted unique identification code in association with a record of each bidding act by the selected bidders associated therewith; and
replacing said encrypted unique identification code in association with a record of each bidding act by the selected bidders associated therewith collected in the course of said public auction with another encrypted unique identification code in association with another record of each bidding act by the selected bidders associated therewith collected in the course of another public auction.

7. A method according to claim 6, wherein:
said step of replacing is effected upon the expiration of a preselected time interval.

8. A method according to claim 7, further comprising the step of:
retrieving said remotely stored data and record to provide a data record for conducting an audit of said public auction.

9. A method according to claim 6, wherein:
the step of replacing said encrypted unique identification code is effected upon the expiration of the limitation period for commencing a civil action.

10. A method according to claim 3, wherein:
the step of replacing said encrypted unique identification code further includes the step of receiving compensation corresponding to said duration.

11. A method according to claim 8, wherein:
the step of replacing said encrypted unique identification code is effected upon the expiration of the limitation period for commencing a civil action.

12. A method according to claim 11, wherein:
the step of replacing said encrypted unique identification code further includes the step of receiving compensation corresponding to said duration.
